(19) United States
(12) Patent Application Publication
(10) Pub. No.: US 2008/0278024 A1
(43) Pub. Date: Nov. 13, 2008

(54) RADIAL STEPPING MOTOR

(75) Inventor: Masaaki Matsubara, Yonago-shi (JP)

Correspondence Address: BRINKS HOFER GILSON & LIONE, P.O. BOX 10395, CHICAGO, IL, 60610, US

(73) Assignee: Minebea Motor Manufacturing Corporation, Meguro-ku (JP)

(21) Appl. No.: 12/053,220

(22) Filed: Mar. 21, 2008

(30) Foreign Application Priority Data
Apr. 24, 2007 (JP) JP2007-114511

(51) Int. Cl. H02K 1/18

(52) U.S. Cl. 310/218

(57) ABSTRACT

The present invention provides a radial stepping motor including: a coil that is comprised of a self-bonding magnet wire wound and fusion-bonded and that has annular surfaces; stator yokes that are supported by the annular surfaces of the coil; and bonding sheets bonding the stator yokes to the coil.

This application claims priority under 35 U.S.C. §119 to Japanese Patent Application No. JP2007-114511 filed Apr. 24, 2007, the entire content of which is hereby incorporated by reference.

### FIELD OF INVENTION

The present invention relates to a radial stepping motor which is configured such that stator yokes are supported by surfaces of a coil comprised of a self-bonding magnet wire which is fusion-bonded and the stator yokes and the coil are bonded by bonding sheets impregnated with an adhesive, so that the motor can be made thinner, the strength of the stator can be improved, and the assembly of the motor can be automated.

### DESCRIPTION OF RELATED ART

In recent years, in mobile devices (for example, mobile phones, personal handyphone systems (PHSs), and personal digital assistants (PDAs)), vibration-generating motors are used for call-reception informing functions or for providing vibration sensations. A vibration-generating motor is required to be more compact and thinner in accordance with the progressive reductions in the sizes of mobile devices. However, due to this, the strength of the vibration-generating motor is deteriorated, and the number of steps required to assemble the motor is increased.

Japanese Unexamined Patent Application Laid-open No. H 7-298532 has proposed a technique for realizing not only miniaturization and thickness reduction of motors but also for reducing the number of steps required for assembly. In this technique, an axial type of brushless motor is assembled by a bonding process of a coil, which uses a thermosetting adhesive, and a connecting process, which uses solder. These processes are simultaneously performed by reflow soldering. Therefore, the number of steps required for assembly is reduced. In addition, a method in which bonding strength of the coil is increased by using a thin insulating sheet and an adhesive has been proposed.

Japanese Unexamined Patent Application Laid-open No. H6-77211 has proposed a technique for providing a thin coil component. In this technique, the coil component has a flat coil, an insulating sheet, a core, and a terminal. The flat coil with a single self-bonding magnet wire or a plurality of self-bonding magnet wires which are grouped is wound in a spiral form in one plane. The insulating sheet is disposed in the flat coil, if necessary. The core has a projection provided at a center portion and a peripheral portion of at least one of facing surfaces of two plates. The terminal connects a lead wire of the flat coil.

In order to realize thickness reduction of the motor described above, it is required that the component of the motor be made thinner. Due to this, the strength may be insufficient, the characteristics of the motor may be unreliable, the number of steps required for assembly is increased, productivity is deteriorated, and production cost is increased.

### BRIEF SUMMARY

The present invention has been made in light of the above problems, and it is an object of the present invention to provide a radial stepping motor which can be made thinner, which can improve the strength of a stator, and which enables an automation of assembly.

According to a first aspect of the present invention, a radial stepping motor includes: a coil which is comprised of a self-bonding magnet wire wound and fusion-bonded and which has annular surfaces; stator yokes which are supported by the annular surfaces of the coil; and bonding sheets which form a bond between the stator yokes and the coil.

In the aspect of the present invention, the stator yokes forming a magnetic circuit are supported by the annular surfaces of the stator coil comprised of the solidified self-bonding magnet wire, and are simultaneously bonded and fixed to the coil by the bonding sheets. Therefore, the motor can be made thinner by the provision of the bonding sheets, and the strength of the stator can be improved. That is, since the shape of the coil and the position of the stator yokes are consistent, the motor can be made thinner and the characteristics of the motor can be reliable. In order that the radial stepping motor reliably produce the desired rotation speed, the stable magnetic force supplied for the stepping drive is required. It is important that the shape of the coil and the position of the stator yokes be consistent in order that magnetic force supplied for the stepping drive be stable. For example, in particular, this is important for vibration-generating motors which have stators in which the shape easily changes with the passage of time. For example, the self-bonding magnet wire is comprised of a conductor, an insulating layer, and a bonding layer. The coil comprised of a self-bonding magnet wire wound and fusion-bonded is a coil formed such that bonding layers, which are proximate to each other when a self-bonding magnet wire is wound, are fusion-bonded by heat treatment or solvent processing, and they are integrated and solidified.

According to a second aspect of the present invention, the bonding sheet is an annular sheet having a thickness of 0.02 to 0.07 mm, and the bonding sheet insulates the coil from the stator yoke. In the aspect, since the bonding sheet has a thickness of about 0.02 to 0.07 mm, which is thin, the aspect may be desirable for a thin motor having a small space for soldering of a coil terminal. In contrast, when the thickness of the bonding sheet is thinner than 0.02 mm, the insulation characteristics of the bonding sheet are deteriorated, so that the characteristics of the motor may be unreliable. When the thickness of the bonding sheet is thicker than 0.07 mm, it may be difficult to make the motor thinner. Since the bonding sheet is formed to be annular according to the shape of the annular coil, the assembly of the bonding sheets may be performed merely by inserting the bonding sheet into the bearing.

According to a third aspect of the present invention, the bonding sheet includes: a base material of a glass fiber fabric; and an epoxy thermosetting adhesive impregnated in the base material. In the aspect, since the bonding sheet is a sheet including the impregnated and dried epoxy thermosetting adhesive, the radial stepping motor can be assembled by heating which is a simple process that can be automated. Therefore, the productivity and the production cost are maintained, and the thin motor having improved strength of the stator can be assembled. In contrast, when the thermosetting adhesive is not impregnated, the application of an adhesive is required, and the number of steps required for the assembly is increased.

According to a fourth aspect of the present invention, the stator yoke includes: a first stator yoke having comb-like first pole teeth; and a second stator yoke having comb-like second pole teeth. The bonding sheets may bond the stator yoke and the coil such that the first pole teeth of the first stator yoke and the second pole teeth of the second stator yoke interdigitate with each other. In the aspect, since the bonding sheets bond and fix the two stator yokes to the coil such that the pole teeth of the first stator yoke and the second stator yoke which are proximate to each other are equidistant from each other, the characteristics of the motor can be reliable. That is, since the distances between the pole teeth of the stator yokes are consistent, magnetic force supplied for the stepping drive can be stable, and the radial stepping motor reliably can produce the desired rotation speed. In particular, this may be important for vibration-generating motors which have a stator in which the shape may easily change with the passage of time.

According to a fifth aspect of the present invention, the radial stepping motor includes: a bearing that magnetically couples the first stator yoke and the second stator yoke. The bearing may position the first stator yoke and the second stator yoke such that the first pole teeth of the first stator yoke and the second pole teeth of the second stator yoke interdigitate with each other. In the aspect, since the radial stepping motor may have the bearing functioning as a part of a magnetic circuit, a core can be removed. Therefore, the number of components and the number of steps required for assembly can be reduced, and the radial stepping motor can be more compact. A space formed by removing a core can be used for winding space of the coil. In this case, since the number of turns of windings can be increased, the magnetomotive force generated at an input lower than a rated input may be equal to that of a motor having a core. That is, the rotation speed can be produced sufficiently. Since the bearing positions the first stator yoke and the second stator yoke such that the pole teeth of the first stator yoke and the second stator yoke, which are proximate to each other, are equidistant from each other, the strength of the stator can be improved, and the characteristics of the motor can be reliable.

In the radial stepping motor of the present invention, the thickness of the motor can be reduced, the strength of the stator can be improved, and the assembly of the motor can be automated.

### BRIEF DESCRIPTION OF THE DRAWINGS

The above object and other advantages of the present invention will become more apparent by describing in detail the preferred embodiment of the present invention with reference to the attached drawings in which;

FIGS. 1A and 1B show a configuration of a radial stepping motor according to a first embodiment of the present invention. FIG. 1A is a cross sectional view of the stepping motor taken along line A-A in FIG. 1B, and FIG. 1B is a cross sectional view of the stepping motor taken along line B-B line in FIG. 1A;

FIG. 2 is an exploded view showing the radial stepping motor of the first embodiment;

FIG. 3 is a block diagram showing a drive circuit of the radial stepping motor of the first embodiment.

### DETAILED DESCRIPTION OF THE PREFERRED EMBODIMENTS

Preferred embodiments of the present invention will be described hereinafter with reference to the drawings.

### 1. FIRST EMBODIMENT

In a first embodiment, one example of a radial stepping motor will be described hereinafter. The radial stepping motor includes stator yokes and a coil. The coil is comprised of a self-bonding magnet wire wound and fusion-bonded and the stator yokes are bonded by bonding sheets impregnated with an adhesive.

### 1.1 Configuration of Radial Stepping Motor

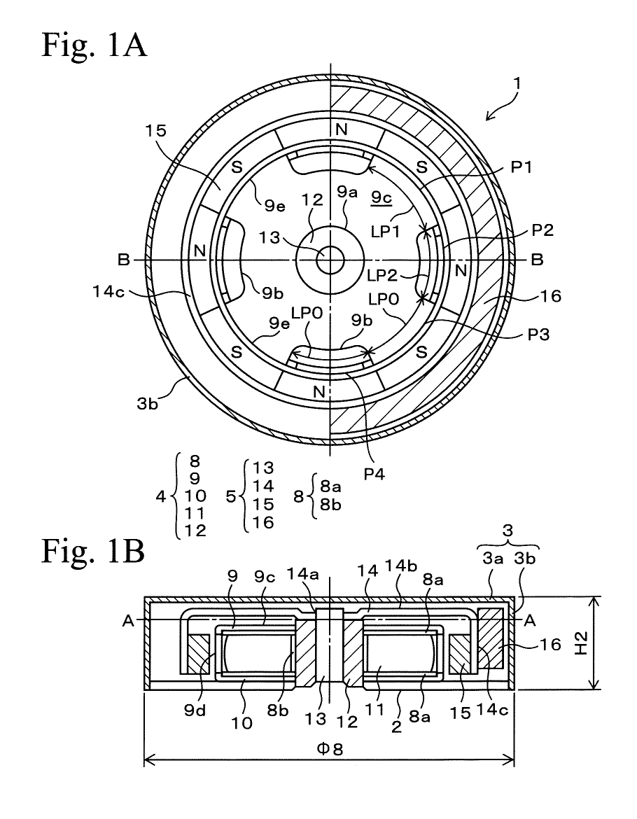

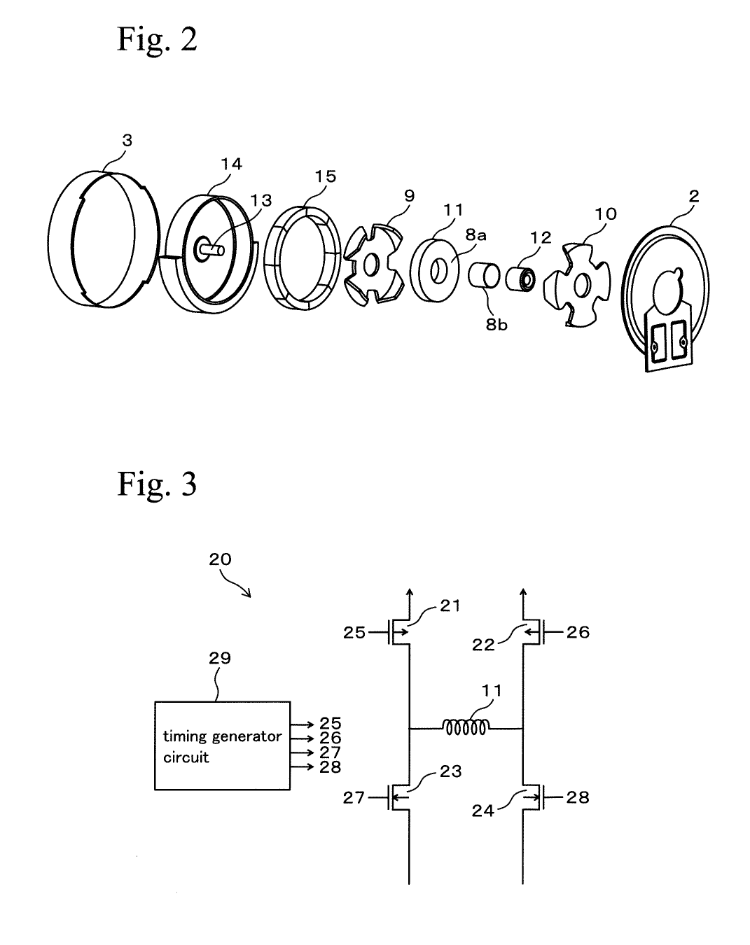

FIGS. 1A, 1B and 2 show a configuration of a radial stepping motor 1. FIG. 1A is a cross sectional view of the stepping motor 1 taken along line A-A in FIG. 1B, and FIG. 1B is a cross sectional view of the stepping motor 1 taken along line B-B line in FIG. 1A. FIG. 2 is an exploded view of the radial stepping motor 1. The radial stepping motor 1 shown in FIGS. 1A, 1B and 2 is an outer rotor-type of motor, and is comprised of a bottom plate 2, a cover 3, a stator 4, and a rotor 5. The radial stepping motor 1 is a compact stepping motor having no core, and is employed for vibration generation. For example, the radial stepping motor 1 has an outer diameter of 8 mm and a height of 2 mm.

The bottom plate 2 is made of a metal material. On an upper surface of the bottom plate 2, a second stator yoke 10 of the stator 4 and a bearing 12 serves as a third stator yoke are fixed. The bottom plate 2 has a substrate and an opening (not shown in the Figures). The substrate has a power feeding line connected to a coil, and is connected to a control circuit, a power supply, and the like, which are outside. A projection, which is formed on an end surface of a cylindrical portion 3b of the cover 3, is fitted in the opening, and is soldered or welded from a rear surface of the bottom plate 2. The bottom plate 2 has an outer diameter of 8 mm.

The cover 3 is made of a metal material (for example, SUS303 (stainless steel)). The cover 3 has a disc portion 3a and the cylindrical portion 3b, and is cup-shaped and approximately C-shaped in cross section. Several projections (not shown in the Figures) are formed on an end surface of the cylindrical portion 3b so as to be bonded and fixed to the bottom plate 2. The cover 3 has an outer diameter of 8 mm and a height of 2 mm.

The stator 4 has an insulating member 8, a first stator yoke 9, the second stator yoke 10, a stator coil 11, and the bearing 12. A self-bonding magnet wire, which has a conductor, an insulating layer, and a bonding layer, is wound and fusion-bonded, so that the stator coil 11 is formed. Specifically, the self-bonding magnet wire is wound by a winding machine, and the bonding layer is softened and fusion-bonded by heating. Then, the stator coil 11 is solidified with a tension during winding, so that the stator coil 11 is integrally formed as an annular coil. The stator coil 11 supports the first stator yoke 9 and the second stator yoke 10 by both annular surfaces of the stator coil 11.

In this feature, the stator yokes forming a magnetic circuit are supported by the surfaces of the annular coil comprised of the solidified self-bonding magnet wire. That is, since the shape of the coil and the positions of the stator yokes are consistent, the characteristics of the motor can be reliable. In order that the radial stepping motor 1 reliably produce desired rotation speed, the stable magnetic force supplied for the stepping drive is required. It is important that the shape of the coil and the positions of the stator yokes be consistent in order that magnetic force supplied for the stepping drive be stable. For example, in particular, this is important for vibration generation motors which have a stator in which the shape easily changes with the passage of time.

The first stator yoke 9 is made of a magnetic material, and has a cup-shape having an opening 9a and cutouts 9b formed at a center portion thereof. The opening 9a is formed at a center portion of a disc portion 9c, and a cylindrical portion 9d is connected around the disc portion 9c. The cutouts 9b are provided at four portions which are equidistant from each other, and they are approximately U-shaped from the cylindrical portion 9d to the disc portion 9c. Pole teeth 9e are formed between the cutouts 9b. The approximately U-shaped cutout 9b is determined based on the shapes of the pole teeth 9e. Each of the first stator yoke 9 and the second stator yoke 10 has a plate thickness of 0.15 mm.

The second stator yoke 10 is made of the same material as the first stator yoke 9, and has the same shape as the first stator yoke 9. The first stator yoke 9 and the second stator yoke 10 are positioned by the bearing 12 so that the comb-like pole teeth of the first stator yoke 9 and the comb-like pole teeth of the second stator yoke 10 are interdigitated with each other. That is, the first stator yoke 9 and the second stator yoke 10 are press-fitted and held in the bearing 12, so that the pole teeth of the first stator yoke 9 and the pole teeth of the second stator yoke 10, which are proximate to each other, are maintained to be equidistant from each other. The stator coil 11 is provided between the first stator yoke 9 and the second stator yoke 10, and the first stator yoke 9 and the second stator yoke 10 are supported by the annular surfaces of the stator coil 11 comprised of the solidified self-bonding magnet wire. The first stator yoke 9, the second stator yoke 10, and the bearing 12 which serves as the third stator yoke are disposed so as to cover the area which surrounds the annular stator coil 11.

The magnetic field generated by the stator coil 11 passes through the pole tooth of the first stator yoke 9, the pole tooth of the second stator yoke 10, the bearing 12, the pole tooth of the first stator yoke 9, etc., in turn. Thus, the pole teeth of the first stator yoke 9 functions as north poles, and the pole teeth of the second stator yoke 10 function as south poles. In this manner, since the stator yokes, which has magnetic poles, that is, a north pole, a south pole, a north pole, etc., in turn, face a ring magnet 15 described below in a radial direction, the stator yokes and the ring magnet 15 repel or attract each other, so that the rotor 5 rotates in a predetermined direction. Since the direction of drive current supplied to the stator coil 11 is changed when the stator yokes and the ring magnet 15 attract each other, the direction of the magnetic field generated by the stator coil 11 is changed such that the magnetic field passes through the pole tooth of the second stator yoke 10, the pole tooth of the first stator yoke 9, the bearing 12, the pole tooth of the second stator yoke 10, etc., in turn. Thus, the pole teeth of the first stator yoke 9 functions as south poles, and the pole teeth of the second stator yoke 10 function as north poles. Hereinafter, the same operations are repeated, and the rotor 5 is continuously rotated.

In one pair of pole teeth P1 and P2, which are proximate to each other, of the comb-like teeth of the first stator yoke 9 and the second stator yoke 10, rotational direction lengths LP1 and LP2 are unequal. On the other hand, in other pole teeth (for example, pole teeth P3 and P4), rotational direction lengths LP0 and LP0 are equal. In this feature, when the supply of the drive current to the stator coil 11 is started after the supply of the drive current to the stator coil 11 is stopped, the rotational direction of the rotor becomes the same direction. FIG. 1A shows the stop condition of the radial stepping motor 1. In this condition, when the rotor 5 rotates in a clockwise direction, the direction of the drive current is adjusted so that the pole tooth P1 of the first stator yoke 9 functions as the south pole. Then, the pole tooth P1 functioning as the south pole is attracted to the north pole of the ring magnet 15. Thus, the rotor 5 rotates in a clockwise direction.

The insulating member 8 has a bonding sheet 8a and an insulating cylindrical member 8b, and electrically insulates the first stator yoke 9, the second stator yoke 10, the bearing 12 which serves as the third stator yoke, and the stator coil 11. The bonding sheet 8a is formed from a glass fiber fabric as a base material and an epoxy thermosetting adhesive is impregnated to the base material and dried. The bonding sheet 8a does not harden at room temperature and is hardened at elevated temperature. The bonding sheet 8a is an annular bonding sheet having a thickness of about 0.02 to 0.07 mm. The bonding sheet 8a is provided between the first stator yoke 9 and the stator coil 11 and between the second stator yoke 10 and the stator coil 11. In this case, the bonding sheets 8a bond the first stator yoke 9 and the second stator yoke 10 to the stator coil 11 such that the pole teeth of the two stator yokes are interdigitated with each other. That is, by means of the bonding sheets 8a, the pole teeth of the first stator yoke 9 and the pole teeth of the second stator yoke 10 which are proximate to each other are bonded equidistantly from each other. Since the bonding sheet 8a is formed to be annular according to the shape of the annular coil 11, the assembly of the bonding sheets 8a may be performed merely by inserting the bonding sheets 8a into the bearing 12.

In this feature, the first stator yoke and the second stator yoke are press-fitted and held in the bearing 12, and the two stator yokes are simultaneously bonded and fixed to the stator coil 11. In addition, the two stator yokes are supported by the annular surfaces of the stator coil 11 comprised of the solidified self-bonding magnet wire. Therefore, the strength of the stator 4 is improved. That is, since the shape of the coil and the positions of the pole teeth of the two stator yokes are consistent, the characteristics of the motor are reliable.

Since an adhesive impregnated in the bonding sheet 8a is thermosetting, only the automated heat treatment is added in the assembly process. Therefore, the productivity and the production cost of the motor are maintained, and the thin motor having the improved strength of the stator can be assembled. Since the bonding sheet 8a has a thickness of about 0.02 to 0.07 mm, which is thin, this feature is desirable for a thin motor having a small space for the soldering of the coil terminal.

The insulating cylindrical member 8b is a cylindrical resin member, and functions as an insulator between the stator coil 11 and the bearing 12. As a substitute for the insulating cylindrical member 8b, the bonding sheet 8a may be used. In this case, the radial stepping motor 1 is assembled with the bearing 12 wound with the bonding sheet 8a in advance. In this feature using the bonding sheet 8a, the radial stepping motor 1 can be also compact in the radial direction. A space brought about by use of the bonding sheet 8a may be used for the winding space of the coil. In this feature, since the magnetomotive force from the coil is increased, the desirable rotation speed can be produced at a lower input.

The bearing 12 is made of an oil-impregnated sintered alloy including 99 mass % or more of iron (Fe). The oil-impregnated sintered alloy has many pores (which function as paths through which air may pass) and oil is impregnated in the pores. Thus, in the bearing 12, the oil impregnated in the pores is exuded by frictional heat generated by rotation of a shaft 13, and an oil film is formed between the bearing 12 and the shaft 13. Therefore, maintenance (for example, oil supply) is not required. Since the bearing 12 is porous, the durability against a biased load due to an eccentric weight is improved, and shaft loss is reduced. The porosity of the bearing 12 is set such that an appropriate amount of lubricant is supplied between the inner peripheral surface of the bearing 12 and the shaft 13. In this case, the supply of oil is not required in general but a reservoir for the supply of oil may be provided. In this feature, the service life of the bearing 12 can be extended. The bearing 12 has a density of about 6.0 g/cm³.

The rotor 5 has the shaft 13, a rotor frame 14, the ring magnet 15, and an eccentric weight 16. The shaft 13 is a cylindrical rod, and an end portion of the shaft 13 is connected to the rotor frame 14. The shaft 13 has an outer diameter of 0.6 mm. The shaft 13 is inserted and supported in the bearing 12. The rotor frame 14 is made of a metal material (for example, iron). The rotor frame 14 has a disc portion 14b having an opening 14 at a center portion thereof and a cylindrical portion 14c connected to the circumferences of the disc portion 14b. The rotor frame 14 is cup-shaped. The shaft 13 is fitted and fixed in the opening 14a of the rotor frame 14. In this case, the rotor frame 14 is spaced from the first stator yoke 9, and is supported by a spacer stacked on the bearing 12. The ring magnet 15 is secured to the inner side surface of the cylindrical portion 14c of the rotor frame 14.

The ring magnet 15 is comprised of appropriately selected magnetic material (for example, neodymium (Nd), iron (Fe), boron (B), samarium (Sm), or cobalt (Co)). The ring magnet 15 is formed such that a cylindrical permanent magnet is multipolarly magnetized, and has 4 pairs of magnetic poles. The ring magnet 15 is secured to the inner side surface of the rotor frame 14, and faces the first stator yoke 9 and the second stator yoke 10 in the radial direction. Thus, magnetic force providing for the rotation is relatively strong, and the desired rotation speed can be produced at a lower input.

The eccentric weight 16 is comprised of a high specific gravity metal material which is, for example, iron(Fe), copper (Cu), lead (Pb), or tungsten (W)), or a sintered alloy including any of them as a main composition. The eccentric weight 16 has a partial ring-shape having a predetermined angle range, and the center angle of the eccentric weight 16 can be appropriately determined based on the specific gravity of the material employed or the like. In this example, the center angle is 180 degrees. The eccentric weight 16 having a partial ring-shape is joined by welding or the like to a circumferential surface of the rotor frame 14. Thus, the position of the eccentric weight 16 is relatively remote from the rotation center, and vibrations are produced effectively.

In a vibration mechanism of the rotor frame 14 having the eccentric weight 16, the vibration amount is expressed as “mrw²”. In the expression, m, r and w are the mass(kg), the distance from the center (m) and the rotation speed (rpm) of the eccentric weight 16, respectively In general, body sensitivity produced at a vibration level of about 1 G is desirable, and the rotation speed in this case is about 9000 rpm. Thus, an outer rotor type of motor having a greater length from the center to the eccentric weight 16 is more advantageous than an inner rotor type of motor. Since the eccentric weight 16 can be formed at a predetermined position on the circumference of the rotor frame 14, the manufacture can be facilitated.

### 1.2 Assembly Method of Motor

An assembly method of the motor will be simply described hereinafter.

First, a self-bonding magnet wire is wound so as to have a predetermined number of turns of windings, a predetermined number of winding steps, and a predetermined tension by a winding machine. The wound self-bonding magnet wire is heated together with a jig, and bonding layers thereof are softened and tightly bonded to each other. In this case, the stator coil 11 is solidified with the tension during winding. Next, the second stator yoke 10 is fixed to the bottom plate 2 (by bonding, adhesion, welding, or the like). Next, the bearing 12 is press-fitted into the second stator yoke 10. Next, the bonding sheets 8a, the insulating cylindrical member 8b, and the stator coil 11 are inserted into the bearing 12. Next, the coil terminals of the stator coil 11 are soldered to the power feeding line of the bottom plate 2. Next, the first stator yoke 9 is press-fitted into the bearing 12, and pressure is applied to the first stator yoke 9 toward the stator coil 11. Finally, the bonding sheets 8a are hardened by heat treatment, and the two stator yokes 9, 10 and the stator coil 11 are bonded.

As described above, in the feature using the coil comprised of the wound and fusion-bonded self-bonding magnet wire and the bonding sheets impregnated with an adhesive, the radial stepping motor can be assembled by the heat treatment which is a simple that can be automated. Therefore, the productivity and the production cost are maintained, and the thin motor having the improved strength of the stator can be assembled.

### 1.3 Drive Circuit

FIG. 3 is a block diagram showing one example of a drive circuit of the radial stepping motor 1. A drive circuit 20 has p-channel Metal-Oxide-Semiconductor Field-Effect-Transistors (p-channel MOSFETs) 25 and 26, n-channel MOSFETs 27 and 28, and a timing generator circuit 29. The drive circuit 20 is connected to the annular stator coil 11, which is a single phase type, and supplies a current to the stator coil 11 to change the current direction alternately.

The p-channel MOSFETs 25, 26 and the n-channel MOSFETs 27, 28 are switching devices, and they change the direction of the current supplied to the stator coil 11. The timing generator circuit 29 is an integrated circuit (IC) which is a microcomputer or the like, and outputs a drive timing signal to the p-channel MOSFETs 25, 26 and the n-channel MOSFETs 27, 28. Instead of the MOSFETs, other switching devices may be used.

The drive timing signal is generated by the timing generator circuit 29, and is supplied to the p-channel MOSFETs 25, 26 and the n-channel MOSFETs 27, 28. At an a-pulse duration, the p-channel MOSFET 25 and the n-channel MOSFET 28 are ON, and the current is supplied to the stator coil 11 in a predetermined direction. On the other hand, at a b-pulse duration, the p-channel MOSFET 26 and the n-channel MOSFET 27 are ON, and the current is supplied to the stator coil 11 in the opposite direction. Hereinafter, the same control is repeated.

The timing generator circuit 29 controls the rotation speed of the radial stepping motor 1 by pulse width modulation (PWM). That is, the timing generator circuit 29 gradually decreases the pulse width during acceleration of the motor 1, so that the switching time of the direction of the current supplied to the stator coil 11 is gradually made shorter. On the other hand, the timing generator circuit 29 maintains the pulse width to be constant during the constant speed of the motor 1, so that the switching time of the direction of the current supplied to the stator coil 11 is maintained so as to have a constant interval. The timing generator circuit 29 gradually increases pulse width during deceleration of the motor 1, so that the switching time of the direction of the current supplied to the stator coil 11 is gradually longer.

In this manner, the rotation speed of the radial stepping motor 1 is controlled in the acceleration condition, the constant speed condition, and the deceleration condition. In the acceleration condition, the rise time to the constant speed is set to be, for example, 0.3 to 0.5 second. In the constant speed condition, the motor is rotated at a speed of, for example, 9000 rpm which is providing a good body sensitivity. In this case, a bias load of about 1 G is applied to the bearing 12. The time period of speed deceleration is desirably as short as possible.

### 1.4 Advantages of First Embodiment

Advantages of the first embodiment will be described hereinafter with reference to FIGS. 1A, 1B, and 2.

### 1.4.1. Thinner Motor

Since the bonding sheet 8a insulating the stator coil 11 from the two stator yokes has a thickness of about 0.02 to 0.07 mm, which is thin, the motor can be made thinner. This feature is desirable for a thin motor having a small space for the soldering of the coil terminal. In contrast, when the thickness of the bonding sheet 8a is thinner than 0.02 mm, the insulation characteristics of the bonding sheet 8a are deteriorated, so that the characteristics of the motor cannot be maintained. When the thickness of the bonding sheet 8a is thicker than 0.07 mm, it is difficult to make the motor thinner. Since the bonding sheet 8a is formed to be annular according to the shape of the annular coil, the assembly of the bonding sheets 8a may be performed merely by inserting the bonding sheets 8a into the bearing 12.

### 1.4.2. Reliability of Motor Characteristics

The first stator yoke 9 and the second stator yoke 10 forming the magnetic circuit are press-fitted and held in the bearing 12, and they are simultaneously bonded and fixed to the stator coil 11 by the bonding sheets 8a. In addition, the two stator yokes are supported by the surfaces of the annular stator coil 11 comprised of the solidified self-bonding magnet wire. Therefore, the motor can be made thinner and the strength of the stator can be improved. That is, since the shape of the coil and the positions of pole teeth of the stator yokes are consistent, the motor can be made thinner and the characteristics of the motor can be reliable. In order that the radial stepping motor 1 reliably produce the desired rotation speed, the stable magnetic force supplied for the stepping drive is required. It is important that the shape of the coil and the position of the pole teeth of the stator yokes be consistent in order that the magnetic force supplied for the stepping drive be stable. For example, in particular, this is important for vibration-generating motors which have a stator in which the shape may easily change with the passage of time.

In contrast, when the two stator yokes are only press-fitted and held in the bearing 12, position shift of the stator yokes with respect to the rotational direction easily occurs. Due to this, the stator yoke is required to have a desired thickness, so that it is difficult to make the motor thinner. In a method in which a coil is wound around a coil bobbin, the thinner a flange of the coil bobbin, the more easily the coil bends. Due to this, the shape of the coil is inconsistent, and the characteristics of the motor are thereby unreliable. Thus, the flange of the coil bobbin is required to have a desired thickness, so that it is difficult to make the motor thinner.

There is a method in which the strength of the stator is obtained by welding the two stator yokes to the bearing 12. However, in this method, since the bearing 12 forms a part of the magnetic circuit, the magnetic property is changed, and the characteristics of the motor are unreliable. There is also a method in which the two stator yokes are fixed by caulking the bearing 12 and the desired strength of the stator is thereby obtained. However, in this method, since caulking space is required, the caulking space interferes with the making of the motor thinner.

### 1.4.3. Automation of Assembly

The stator coil 11 is comprised of the self-bonding magnet wire which is fusion-bonded and solidified by heat treatment, and the bonding sheet 8a is a sheet including an impregnated and dried epoxy thermosetting adhesive. Thus, the radial stepping motor 1 can be assembled merely by heating which is a simple process that can be automated. Therefore, the productivity and the production cost of the radial stepping motor 1 are maintained, and the thin motor having the improved strength of the stator can be assembled. In contrast, when the thermosetting adhesive is not impregnated, the application of an adhesive is required, and the number of steps required for the assembly is increased.

### INDUSTRIAL APPLICABILITY

The present invention can be applied to radial stepping motors and vibration-generating stepping motors, which can be made thinner, which can improve the stator strength, and which enables an automation of assembly. The present invention can be applied to mobile phones, PHSs, PDAs, and the like, which use the above motor.

1. A radial stepping motor comprising:
a coil comprising a self-bonding magnet wire wound and fusion-bonded and having an annular surface;
a stator yoke supported by said annular surface of said coil; and
bonding sheets bonding said stator yoke to said coil.

2. A radial stepping motor according to claim 1, wherein said bonding sheet is an annular sheet having a thickness of 0.02 to 0.07 mm, and insulates said coil from said stator yoke.

3. A radial stepping motor according to claim 2, wherein
said bonding sheet comprising:
a base material of a glass fiber fabric; and
an epoxy thermosetting adhesive impregnated in said base material.

4. A radial stepping motor according to claim 1, wherein
said stator yoke comprising:
a first stator yoke having comb-like first pole teeth; and
a second stator yoke having comb-like second pole teeth, wherein
said bonding sheets bond said stator yoke to said coil such that said first pole teeth of said first stator yoke and said second pole teeth of said second stator yoke interdigitate with each other.

5. A radial stepping motor according to claim 4, wherein
said radial stepping motor comprising:
a bearing magnetically coupling said first stator yoke and said second stator yoke, wherein
said bearing positions said first stator yoke and said second stator yoke such that said first pole teeth of said first stator yoke and said second pole teeth of said second stator yoke interdigitate with each other.
